(19) United States
(12) Patent Application Publication
(10) Pub. No.: US 2024/0116002 A1
(43) Pub. Date: Apr. 11, 2024

(54) SYSTEMS AND METHODS FOR DIRECT LITHIUM HYDROXIDE PRODUCTION

(71) Applicant: ENERGY EXPLORATION TECHNOLOGIES, INC., Austin, TX (US)

(72) Inventors: Amit PATWARDHAN, Austin, TX (US); Teague EGAN, Austin, TX (US)

(73) Assignee: ENERGY EXPLORATION TECHNOLOGIES, INC., Austin, TX (US)

(21) Appl. No.: 18/264,694

(22) PCT Filed: Feb. 9, 2022
(86) PCT No.: PCT/US2022/015850

§ 371 Date: Aug. 8, 2023

Related U.S. Application Data
(60) Provisional application No. 63/147,656, filed on Feb. 9, 2021.

(51) Int. Cl. B01D 61/44; B01D 9/00; B01D 15/36; B01D 61/46; B01D 61/58; B01D 69/14; B01D 71/02

(52) U.S. Cl. CPC B01D 61/445; B01D 9/0059; B01D 15/361; B01D 61/465; B01D 61/466; B01D 61/58; B01D 69/14111; B01D 71/028; B01D 2009/0086; B01D 2311/08

(57) ABSTRACT

This disclosure provides systems and methods for direct production of lithium hydroxide by utilizing cation selective, monovalent selective, or preferably lithium selective membranes. Lithium selective membranes possess high lithium selectivity over multivalent and other monovalent ions and thus prevent magnesium precipitation during electrodialysis (ED) and also address the presence of sodium in most naturally occurring brine or mineral based lithium production processes.

This application claims the benefit of priority to U.S. Provisional Application No. 63/147,656, filed on Feb. 9, 2021, the entire contents of which are hereby incorporated by reference.

### FIELD

The present disclosure relates to simplified and reduced-cost processes for directly producing high purity lithium products, especially lithium hydroxide monohydrate, without the need to produce a lithium carbonate precursor from brine and mineral resources.

### BACKGROUND

The largest lithium resource and production areas in the world are the lithium bearing brines in South America. Lithium demand pressure has already made the previously uneconomic hard rock lithium resources now viable too, with a significant proportion of new supply coming from these sources, which are predominantly located in Australia. There has also been a shift in the demand projections for lithium precursors, namely lithium carbonate and hydroxide, with future projections favoring the hydroxide.

To produce lithium from any of the above resources, currently a lithium carbonate precursor must be produced followed by its conversion to lithium hydroxide. This presents a large and potentially unnecessary cost when the ultimate goal is lithium hydroxide. This is, however, necessitated as a commercially viable path directly to lithium hydroxide is not currently available. A few of the potential benefits of bypassing lithium carbonate production are described by (Grageda et al., 2020) while demonstrating the feasibility of this approach using very clean brines with very low Li/Na,K and Li/Mg,Ca ratios, compared to realistic brines before pre-polishing or removal of impurity ions. Despite use of such cleaned brines, Grageda et al. report significant contamination of their lithium hydroxide product with monovalent impurity cations.

Naturally derived lithium brine concentrate, e.g., pond evaporated brine, contains a large proportion of non-lithium cations such as Na, K, Mg, and Ca. The Na ion, in particular, is pervasive in the lithium extraction process, and lithium bearing brines are virtually always saturated with NaCl together with large amounts of KCl. In several hard rock sources such as jadarite, Na is part of the lithium mineral itself. Caustic leaching of spodumene also introduces a large excess of Na. Even in the more prevalent acid roasting of spodumene, Na content in the leach is typically more than 25% of the lithium content. As the above resource materials are processed, Na₂CO₃ is added to remove Ca and then to finally precipitate lithium carbonate, which also adds more Na to the process.

While purified lithium chloride or sulfate brine can be subjected to membrane electrodialysis to produce relatively clean lithium hydroxide and acid solutions, the pre-membrane purification steps can be costly. Membrane electrodialysis for lithium separation from brines is reviewed in Gmar & Chagnes, 2019. Conventional cation selective electrodialysis (ED) membranes are not selective between Li and Na, K, Ca or Mg. Therefore, in the presence of non-lithium impurity cations, the membranes pass the impurity cations along with lithium to yield a mixed hydroxide and reduce the efficiency of electric current utilization for lithium production (Zhao et al., 2020). As a result, ED on high sodium lithium brines not only results in Na contamination of the LiOH product, but also consumes excessive electricity to transport the unwanted Na⁺ ions along with Li⁺ ions. Even more significantly, the divalent hydroxides are very insoluble and will precipitate inside the ED cell making this operation impossible.

Nemaska Lithium Inc. has studied and piloted a process to produce LiOH directly from spodumene from the Whabouchi deposit in Canada. To accomplish this, a very deep cleaning of the leach liquor is utilized, involving primary and secondary impurity removal steps followed by ion exchange before membrane electrodialysis is utilized (Bourassa et al., 2020). Feed to the electrodialysis membrane contained 5.8 and 0.2 mg/L Ca and Mg, respectively, with a Li/Na ratio of 4. The catholyte (LiOH stream) contained a similar Li/Na ratio, indicating very little selectivity between the two. Highest catholyte Ca and Mg reported were 4 and 0.55 mg/L, respectively, in the [OH⁻] background of nearly 2M. On average, the Ca level was 3.8 mg/L and Mg was below the detection limit of 0.07 mg/L in the catholyte at 6% LiOH solution.

Buckley et. al. (2020) also specify feed brines containing a very stringent requirement of no more than 150 ppb Mg+Ca (preferably <50 ppb each) for electrodialysis to lithium hydroxide using conventional ED membranes. Conventional ED membranes are not monovalent-divalent selective. Even the more modern selective membranes often have Li—Mg selectivities only ranging from 8-33 (Gmar & Chagnes, 2019).

Qiu et al., 2019, demonstrate a five-step separation process on a sodium/potassium-free feed brine utilizing two steps of electrodialysis with monovalent selective membranes, precipitation and ion exchange to separate Mg from Li, and then bipolar electrodialysis to produce LiOH. Several studies have reported the ability to use Bipolar Membrane Electrodialysis (BPMED) for production of LiOH from clean solutions containing lithium (Bunani, Arda, et al., 2017; Bunani, Yoshizuka, et al., 2017; Jiang et al., 2014). Bipolar membrane electrodialysis is similar to membrane electrodialysis where anions and cations are selectively transported across semi-permeable membranes under an electric potential to drive the ions and achieve their separation from the carrier such as water. Bipolar membranes typically comprise cationic and anionic exchange membranes sandwiched together with a hydrophilic interface at their junction. Under an applied current, water molecules migrating to the hydrophilic junction are split into H⁺ and OH⁻ ions, which migrate to produce acids and bases with other anions and cations. Bunani, Arda, et al., 2017 achieved a separation of Li and B as LiOH and boric acid at 99.6% and 88.3%, respectively, using bipolar electrodialysis membranes. Elsewhere, Bunani, Yoshizuka, et al., 2017, also showed a high recovery while achieving a Li concentration factor of approximately 10×. However, in the presence of other cations like Na⁺ in solution only a low Li—Na selectivity of around 2 was achieved. This presents a key challenge for pursuing a path to direct LiOH production, especially based on natural resources that have not undergone significant prior purification steps.

Based on the existing literature, before ED can be attempted, extensive reduction of divalent/multivalent ions is necessary and is conventionally attempted via lime addition followed by softening. However, this still leaves appreciable amounts of Mg depending on the liming pH as well as the amount of Ca in solution. Moreover, monovalent impurities such as Na and K remain in solution with the Na content actually increases due to addition of Na for Ca removal. This approach still faces the same shortcomings even though the precipitation and scaling issues are potentially is reduced. The product is still a mixture of LiOH and NaOH and needs more extensive treatment using multiple fractional crystallizations and ion exchange. Even if the divalent/multivalent cations are removed to ultra-low levels using ion exchange before electrodialysis, the high Na levels result in low current efficiency and produces a mixed hydroxide product. Meng et al., 2021 review such approaches to producing lithium carbonate and hydroxide.

Due to the above and related challenges, the only commercially practiced route to LiOH production involves numerous steps, as shown in FIG. 1a below, and produces the intermediate product, lithium carbonate. The concentrated brine from evaporation ponds at about 2-6% Li content contains appreciable amounts of B, Mg and Ca, in addition to Na. Boron is traditionally removed from the brine by solvent extraction using water-insoluble alcohol solvents. Subsequently, Mg and Ca are removed by precipitation using the lime-soda softening process. The brine is treated with lime Ca(OH₂) at a pH exceeding 10 to precipitate magnesium, iron, silica and other heavy metal impurities. The precipitates are voluminous and require extensive solid/liquid separation to separate the brine from the solids. Multiple stages of countercurrent washing and filtration are required to minimize lithium losses in the adhering liquor to the solids. The brine is then saturated with Ca, which is precipitated as CaCO₃ by addition of a controlled amount of soda ash (Na₂CO₃) to prevent co-precipitation of lithium carbonate. The brine is then relatively clean, containing essentially Li and Na cations with <10 ppm of Mg and <30 ppm of Ca. Separation of Na from Li is difficult to conduct in a manner that leaves Li aqueous. Hence, Li is precipitated as lithium carbonate to separate it from sodium which remains aqueous. The lithium carbonate product is crude and must be purified. For this, lithium carbonate is dissolved under CO₂ to increase its solubility. The dissolved solution is filtered to remove small amounts of insolubles, followed by ion exchange to remove the small amounts of dissolved impurities like Na. CO₂ from the clean brine is then stripped with clean steam to re-precipitate battery-grade lithium carbonate. To produce LiOH, the battery grade lithium carbonate is again dissolved and causticized with lime, then separated from precipitates and the resulting LiOH solution is evaporatively crystallized. Due to re-addition of some impurities with lime, the lithium hydroxide product may need to be redissolved, polished further using ion exchange and recrystallization. In some instances, the crude lithium carbonate is directly advanced to the LiOH process. However, in these situations due to the higher impurity loading, additional ion exchange and multiple recrystallizations of LiOH are necessitated. These steps are represented in FIG. 1a.

Another emerging approach for lithium brine concentration utilizes mechanical separations and thermal evaporation instead on the solar evaporation and is referred to as Direct Lithium Extraction (DLE). FIG. 2 shows the general steps involved which are a rough separation of Li from major impurities such as Na, K, Mg and Ca using ion exchange, ion sorption or solvent extraction. This is followed by additional removal of multivalent ions using nanofiltration. Reverse osmosis is then used to concentrate the brine (Li with the remaining impurities) by separation of water to the point where the pressures required to drive reverse osmosis become impractical. Additional Li and impurity concentration then follows using thermal evaporation. The concentrated brine then flows into the processing plant following the same steps shown in FIG. 1a.

What is needed are more efficient processes for making LiOH from admixtures containing Li, particularly naturally occurring sources such as brine, without necessitating pre-purification of feed brine to the ED or separation membrane and, in particular, without requiring production of the intermediate, lithium carbonate.

### SUMMARY

Using a suitable membrane such as LiTAS™, some or most of the currently used processing steps can be eliminated, resulting in much more efficient lithium hydroxide production from lithium-containing resources such as concentrated feed from direct lithium extraction processes, brine evaporation ponds, or by other means such as rock leachates.

The present disclosure provides methods for producing a substantially clean LiOH solution directly from admixtures containing Li and one or more impurities, by feeding the admixture to an electrodialysis or BPMED cell containing an ion selective membrane, and operating the ion selective membrane under a potential difference to obtain a separate LiOH solution, wherein the separate LiOH solution contains from about 2 to 14 wt % LiOH, Mg in the range of about 0 to 3 ppm, and Ca in the range of about 0 to about 5 ppm. Other LiOH concentrations within the separated LiOH solution also are possible. In a preferred embodiment, the ion selective membrane is contained with a BPMED cell.

In one case the admixture contains lithium in amounts of about 1,500 to about 60,000 ppm. In another, the admixture contains impurity ions selected from the group consisting of monovalent and divalent cations and divalent anions. The impurity ions may be selected from the group consisting of Mg, Ca, Na and K ions. In one aspect, the admixture contains a ratio of Li/Mg ions in the range of about 3 to about 20. In another aspect, the admixture contains a ratio of Li/Ca ions in the range of about 5 to about 10. In yet another aspect, the admixture contains a ratio of Li/Na and Li/K ions in the range of about 1.5 to about 70. Preferably, the admixture is a concentrated lithium brine from a process selected from the group consisting of pond evaporation, direct lithium extraction, and leaching of lithium minerals using water or acid. The admixture may comprise a rock leachate, such as from spodumene, jadarite, hectorite clays, zinnwaldite, or other lithium bearing minerals.

In one aspect, the ion selective membrane is selected from the group consisting of a lithium selective membrane, a monovalent cation selective membrane, or a cation over anion selective membrane. In a preferred embodiment, the ion selective membrane is a lithium selective membrane having a selectivity in the range of 10-100. In a particularly preferred embodiment, the ion selective membrane is a lithium selective membrane comprising a polymer matrix and metal organic framework (MOF) particles disbursed therein. In another embodiment, the cation selective membrane is a cation over anion selective membrane and liming is performed before feeding the admixture to the ED cell containing the membrane.

In a preferred embodiment, the process bypasses or at least significantly mitigates the need for formation of lithium carbonate as a precursor to LiOH. In another aspect, the process is substantially free of lithium carbonate formation as a precursor to LiOH. In another embodiment, partial lithium separation as lithium carbonate, phosphate, oxalate or other precipitates may be produced from the feed brine, and the remaining lithium-containing feed then advances through electrodialysis to directly produce LiOH. Preferably, the resulting lithium hydroxide solution is then crystallized to produce lithium hydroxide monohydrate with a purity in the range of about 95 to 99.9 wt %. In another aspect the lithium hydroxide solution comprises lithium hydroxide in the range of from 5 to 14 wt %.

In another embodiment, boron solvent extraction is performed before feeding the admixture to the ED cell or membrane. In yet another embodiment, the admixture is an evaporated concentrate from a series of brine ponds and the method further comprises membrane separation of Mg and recycle of the separated Mg to previous ponds for precipitation to produce a lower Mg content Li-concentrated feed brine substantially as disclosed in co-pending U.S. patent application Ser. No. 17/602,808, titled Systems and Methods for Recovering Lithium from Brines, which is hereby incorporated by reference herein in its entirety.

The present disclosure also provides a system configured to directly produce LiOH substantially without producing a lithium carbonate precursor. The system includes an ED or BPMED cell containing an ion selective membrane selected from the group consisting of a lithium selective membrane, a monovalent selective membrane, or a cation over anion selective membrane; a feed inlet upstream of the membrane and configured to receive an admixture comprising a concentrated lithium brine from a process selected from the group consisting of pond evaporation, direct lithium extraction, and leaching of lithium minerals using water or acid; and an outlet downstream of the membrane configured to convey a LiOH solution containing from about 2 to about 14 wt % LiOH, Mg of less than 25 ppm, and Ca of less than 50 ppm. In some embodiments, the LiOH solution contains less 20 ppm, 15 ppm, 10 ppm, and 5 ppm of Mg. The LiOH solution may comprise from about 1 ppm to about 50 ppm of Mg, from about 2.5 ppm to about 75 ppm of Mg, from about 5 to about 50 ppm of Mg, or from about 5 ppm to about 25 ppm of Mg. In some embodiments, the LiOH solution contains less 50 ppm, 45 ppm, 40 ppm, 35 ppm, 30 ppm, 25 ppm, 20 ppm, 15 ppm, 10 ppm, and 5 ppm of Ca. The LiOH solution may comprise from about 1 ppm to about 50 ppm of Ca, from about 2.5 ppm to about 75 ppm of Ca, from about 5 to about 50 ppm of Ca, or from about 5 ppm to about 25 ppm of Ca.

In a preferred embodiment, the system includes a membrane that is a lithium selective membrane. In one aspect, the membrane is a lithium selective membrane comprising a polymer matrix and MOF particles disbursed therein. In another aspect, the lithium selective membrane has a selectivity in the range of Li/Mg,Ca of at least 10 and Li/Na, K of at least 3.

### BRIEF DESCRIPTION OF THE FIGURES

FIG. 1 shows (a) a conventional process for LiOH production, (b) a simplified low-cost lithium selective ED membrane-based production process for LiOH production, and (c) application of the membrane-based process of (b) optionally after feed brine liming and softening.

FIG. 2 shows a typical direct lithium extraction (DLE) process block flow diagram showing the general steps to mechanically concentrate and separate lithium from impurities instead of using solar evaporation ponds.

FIG. 3 shows bipolar membrane electrodialysis of feed brine containing unwanted monovalent and divalent cations and divalent anions with a highly Li selective, e.g., LiTAS™, membranes to directly produce a clean LiOH solution.

FIG. 4 shows bipolar membrane electrodialysis of a typical low-sulfate Chilean evaporation pond-concentrated lithium feed brine using (a) a conventional cation selective electrodialysis membrane, (b) a lithium selective membrane, and (c) a bipolar membrane electrodialysis using a cation over anion selective membrane after lime-soda softening of feed brine to remove multivalent impurities like Mg and Ca.

FIG. 5 shows bipolar membrane electrodialysis of a typical Argentinian evaporation pond-concentrated lithium feed brine using (a) a conventional cation selective electrodialysis membrane, (b) a lithium selective membrane, and (c) cation over anion selective membrane after lime-soda softening of feed brine.

FIG. 6 shows bipolar membrane electrodialysis of spodumene sulfuric acid roasted leach using (a) a conventional cation selective electrodialysis membrane, (b) a lithium selective membrane, and (c) a cation over anion selective membrane after lime-soda softening.

### DETAILED DESCRIPTION OF PREFERRED EMBODIMENTS

Using a suitable selective membrane, some or most of the currently used processing steps can be eliminated, resulting in much more efficient production of lithium hydroxide from lithium-containing resources such as evaporated brine and rock leachates. “Selectivity” with reference to, for example, lithium selectivity, is defined here as the ratio of Li ions recovered/feed Li concentration, to the ratio of other ion recovered/other ion feed concentration.

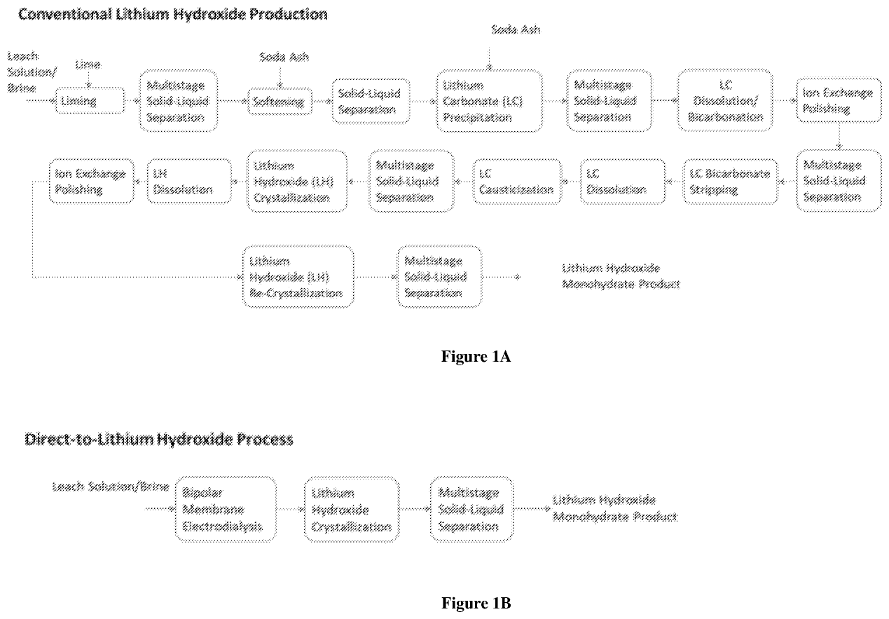

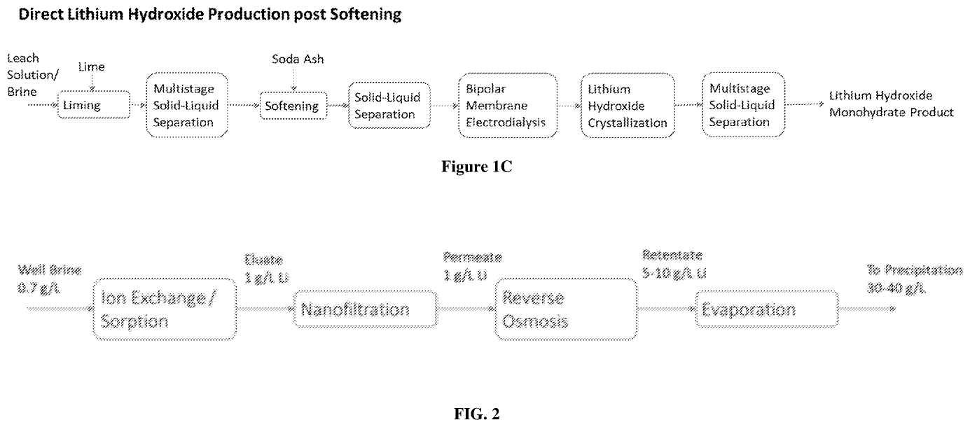

As shown in FIG. 1b, brine or mineral leach solutions (e.g., lithium chloride or sulfate liquor) can be directly subjected to electrodialysis using a lithium selective cationic membrane. The lithium selective cationic membrane largely permits only lithium ions to transfer, producing a high concentration lithium hydroxide solution ready for evaporative crystallization. Thus, application of, for example, a highly Li/Na selective ED membrane can provide a pathway to direct LiOH production from less concentrated and impure brines, and can eliminate the intermediary Li₂CO₃ processing requirement, and associated capital and operating costs.

As shown in FIG. 1c, if the Mg, Ca loading of the feed brine is high, lime-soda softening steps may optionally be performed before electrodialysis directly to LiOH, again bypassing intermediary Li₂CO₃ processing requirements. Significant capital and operating cost savings are still retained in this process.

By “direct” or “directly” herein with reference to LiOH production, we mean systems and processes which are capable of substantially bypassing production of the intermediate lithium carbonate precursor to LiOH and, in most cases, also bypassing pre-polishing of naturally occurring brine, Li-containing rock leachate, or feed from DLE processes. Advantageously, we have found that the methods and systems taught herein substantially reduce the number of processing steps to yield highly concentrated LiOH from Li-containing feed stock that includes naturally occurring and/or other impurities. The resulting LiOH solutions can readily be crystallized by e.g. evaporation to yield substantially pure (for example 95 to 99.9% pure) lithium hydroxide monohydrate. In some embodiments, the methods or systems produce a final lithium product, such as LiOH, that is greater than about 90 wt. %, 92.5 wt. %, 95 wt. %, 96 wt. %, 97 wt. %, 98 wt. %, 99 wt. %, 99.5 wt. %, 99.9 wt. %, or more pure. In some embodiments, the methods or systems produce a final lithium product that is from about 90 wt. % to about 99.999 wt. % pure, from about 92.5 wt. % to about 99.99 wt. % pure, from about 95 wt. % to about 99.9 wt. % pure, or from about 96 wt. % to about 99 wt. % pure,

As used herein, the term “cation selective electrodialysis membranes” or “cation exchange membranes” or “cation over anion selective membranes” means membranes that are selective between cations and anions, but are not selective between cations such as Li and Na, K, Ca or Mg. Therefore, in the presence of non-lithium impurity cations, such membranes pass the impurity cations along with lithium to yield a mixed hydroxide. “Monovalent selective membranes” or “monovalent selective cation exchange membranes” means membranes that are selective between monovalent and divalent ions, and thus permit monovalent ions such as Na, K and Li while retarding divalent/multivalent cations, like Ca or Mg. “Monovalent selective membranes” can also be monovalent selective anion exchange membranes that permit passage of essentially only monovalent anions like Cl⁻ or F⁻ while retarding divalent anions like SO₄²⁻. “Conventional electrodialysis membranes” means membranes that discriminate between cations and anions and are essentially non-selective between monovalent and divalent ions.

“Electrodialysis” means using one or more ion exchange membranes to separate ions from a feed stream into different ion streams under an applied electric potential difference. Any suitable electric potential difference can be used, for example, but not limited to, electrical current in the range of 400 to about 3000 A/m².

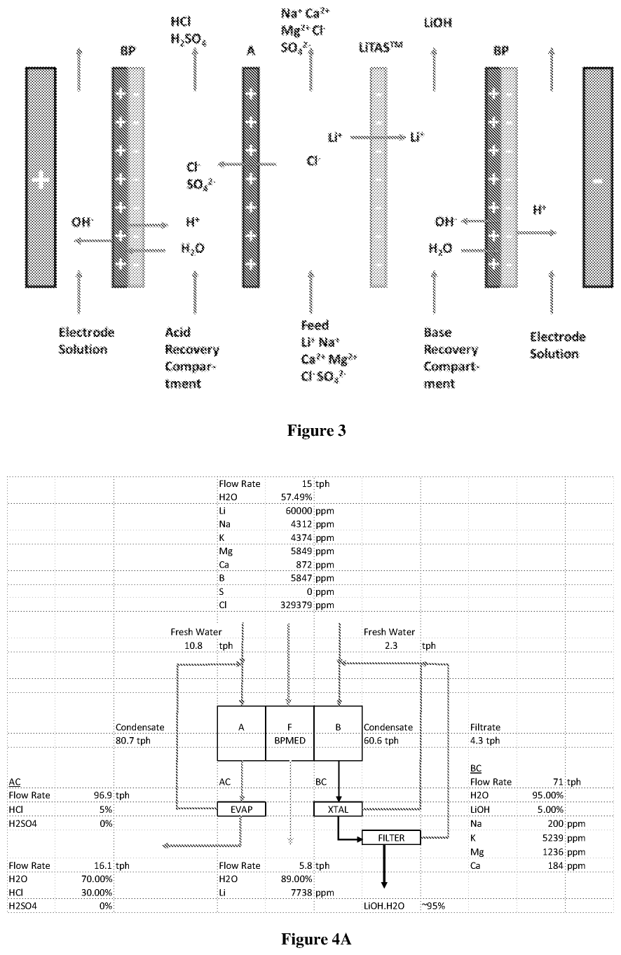

“Bipolar membrane electrodialysis” or BPMED means an electrodialysis process or system, wherein anions and cations are selectively transported across semi-permeable membranes under an electric potential to drive the ions and achieving their separation from a carrier such as water. Bipolar membranes typically comprise cationic and anionic exchange membranes sandwiched together with a hydrophilic interface at their junction. Under an applied current, water molecules migrating to the hydrophilic junction are split into H⁺ and OH⁻ ions, which migrate to produce acids and bases with other anions and cations. A typical BPMED system as used herein is shown in FIG. 3 by way of illustration only; various other BPMED setups are possible using the teachings herein.

The feed compositions herein may contain impurity ion ratios of Li/Mg typically greater than 3, more typically greater than 5, and Li/Ca ratios greater than 1.5, typically greater than 3.5. The feed lithium content is typically greater than 1,000 ppm, greater than 5,000 ppm, or greater than 10,000 ppm. For example, the feed used herein may have compositions containing unwanted impurity ions (such as monovalent and divalent cations and divalent anions) with impurity ion ratios of Li/Mg from 3 to 20, typically from 5 to 15, and Li/Ca ratios from 5 to 100, typically from 20 to 50, and Li/Na,K ratios from 1.5 to 10, typically from 3.5 to 7.5 and a feed lithium content typically from 1000 to 60,000 ppm, preferably from 5000 ppm to 25,000 and, in the case of pond evaporated brines, typically from 10,000 to 60,000 ppm.

Resulting LiOH solutions from the methods and systems disclosed herein will typically contain highly concentrated LiOH. For example, LiOH concentration ranges of about 2 to 14% by weight LiOH can be achieved. In some embodiments, the LIOH concentration is at least 5%. Other concentrations are also possible. Advantageously, these concentrations can readily be crystallized to yield substantially pure lithium hydroxide monohydrate.

With reference to the embodiments of FIGS. 1b and 1c, the present disclosure provides selective membrane electrodialysis to render most of the current process steps (FIG. 1a) and intermediary lithium carbonate precipitation unnecessary. The inventors have found that the required membrane Li/Mg,Ca selectivity is a function of the feed Li/Mg and Li/Ca ratios. For Li/Mg and Li/Ca ratios greater than 10 as is typical for Chilean concentrated brines, a Li/Mg,Ca selectivity greater than 10 is preferred, and more preferably the Li/Mg,Ca selectivity is greater than 30, or greater than 50. For feed Li/Mg ratios less than 10, as may be the case for some Argentinian brines, Li/Mg selectivity greater than 75 is preferred. Around a feed Li/Mg ratio of 2-5, the approach represented in FIG. 1c is optionally used and involves chemical precipitation of Mg before performing direct electrodialysis to LiOH. In this case, the preferred Li/Mg selectivity may be approximately 10 or greater, and preferably greater than 30. In all cases, a higher Li/Na,K selectivity exceeding 10 is beneficial but not required, and is especially beneficial for the approach shown in FIG. 1c. Given the teachings herein, suitable selectivities may be chosen based on the feed impurity contents, such that a membrane of a stated selectivity directly yields a non-precipitating LiOH solution, preferably with maximum Mg and Ca contents of less than or equal to about 25 ppm and about 50 ppm, respectively. These Ca and Mg numbers are higher than what can be calculated using the solubility products of Kₛₚ(Mg(OH₂))=5.61E-12 and Kₛₚ(Ca(OH₂))=5.02E-6 (Lide, 2004). However, as referred to by Bourassa et. al. (2020) higher concentrations of Ca and Mg up to 4 and 0.55 mg/L were reported during a long pilot run producing LiOH using electrodialysis from an ultra purified brine. Without wishing to be bound by theory, the higher levels of Ca and Mg compared to those calculated from solubility products indicate some stabilizing mechanism that allows them to remain in solution, probably due to the activities of components and stabilizing influence of other impurity ions. The inventors have experimentally verified that up to 25 mg/L of and Mg and 50 mg/L of Ca can remain in stable non-settling solutions in a 5% LiOH solution.

It should be understood that membranes useful in embodiments of the present disclosure can include any membrane which can achieve separation of at least a portion of monovalent ions or lithium from one or more impurities, and preferably targeted monovalent-monovalent and/or monovalent-multivalent separations.

As an example, one particularly suitable membrane is a LiTAS™ membrane. Such membranes have been shown to possess monovalent-divalent ion selectivity up to and greater than 500 utilizing metal organic frameworks (MOFs) components. Such membranes also have demonstrated a corresponding Li—Mg selectivity of 1500 (Lu et al., 2020). LiTAS™ membranes can also be provided incorporating Li—Na selective MOFs which have demonstrated selectivities of around 1000.

By “LiTAS™” membrane technology, we mean lithium-ion transport and/or separation using metal organic framework (MOF) nanoparticles in a polymer carrier. MOFs have exceptionally high internal surface area and adjustable apertures that achieve separation and transport of ions while only allowing certain ions to pass through. These MOF nanoparticles are materialized like a powder, but when combined with polymer the combined MOF and polymer can create a mixed matrix membrane embedded with the nanoparticles. The MOF particles create a percolation network, or channels, that allow selected ions to pass through. When extracting lithium, the membrane is placed in a module housing. Feed such as evaporated brine is pumped through the system with one or more layers of membranes that conduct effective separation even at high salinities. While current separator technology can fall short in one area or another, LiTAS™ is particularly preferred and effective. LiTAS™ Membrane Technology U.S. Patent Application No. 62/892,439, filed Aug. 27, 2019, International Patent WO Publication Number 2019/113649A1, published Jun. 20, 2019, and International Patent Application Number PCT/US2020/047955, filed Aug. 26, 2020, are hereby incorporated herein by reference in their entireties. In particular, the LiTAS™ membrane may be a polymer membrane comprising one or more nanoparticles. In particular, the nanoparticles in the membrane may comprise one or more metal-organic frameworks (MOFs) such as UiO-66, UiO-66-(CO₂H)₂, UiO-66-NH₂, UiO-66-SO₃, UiO-66-Br, or any combination thereof. Other MOFs include ZIF-8, ZIF-7, HKUST-1, UiO-66, or a combination thereof.

Membranes for use herein can also be monovalent selective cation exchange membranes with sufficiently high lithium/divalent selectivity depending on feed brine Mg content and the type of application (FIG. 1b or 1c). For example, Nie et al., 2017, refer to monovalent selective membranes for Li—Mg separation from high Mg content brines achieving high Li recovery and a good selectivity of 20-33.

Another example is a membrane containing ionophores, which are materials that transport specific ions across semi-permeable surfaces or membranes as discussed in Demeter et. al., 2020. Such ionophores are based on 14-crown-4 crown ether derivatives. Other potential examples are supported liquid membranes or ionic liquid membranes in electrodialysis, as described in a review article by Li et al., 2019 where cation selective membranes (with Li—Mg selectivity between 8-33, Li—Ca selectivity around 7, Li—Na selectivity around 3, and Li—K selectivity around 5) are described.

Referring now to FIG. 3, LiTAS™ membranes applied in a BPMED setup are shown. In this setup, the electrodialysis cell is set up into three compartments in addition to the electrode rinse channels adjacent to the end electrodes. The three-compartment unit containing a cation exchange membrane, bipolar membrane and an anion exchange membrane are set up as repeating units. Any number of repeating units can be provided in the ED or BPMED cells contemplated herein. The cation exchange membrane in this example is a Li-selective membrane allowing essentially only lithium ions and water along with minor amounts of impurities to permeate. These membranes could also be monovalent selective, which permit monovalent ions such as Na, K and Li while retarding divalent/multivalent cations, like Ca or Mg. The bipolar membrane is a sandwiched cation and anion exchange membrane as described above. The positively charged anion exchange membrane substantially permits only the negatively charged anions to pass, repulsing the positively charged cations. These membranes may also be monovalent selective, permitting essentially only monovalent anions like chloride to permeate relative to the divalent anions such as sulfate.

The feed enters the central compartment in each repeating unit. With a Li-selective membrane, substantially only Li permeates through the membrane into the adjacent base recovery compartment. Similarly, anions permeate through the anion exchange membrane to the acid recovery compartment. The bipolar membranes on the other side of the compartments provide either H⁺ ion to the acid recovery compartment or OH⁻ ions to the base recovery compartment. In this fashion, a clean LiOH stream can be produced directly from the feed brine or leach solution.

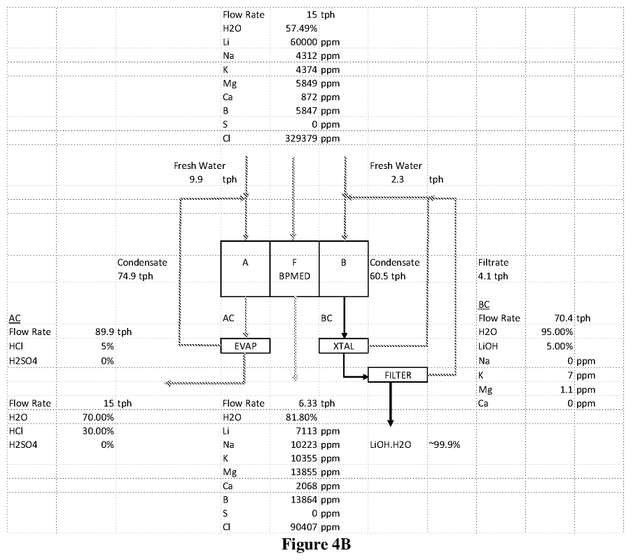

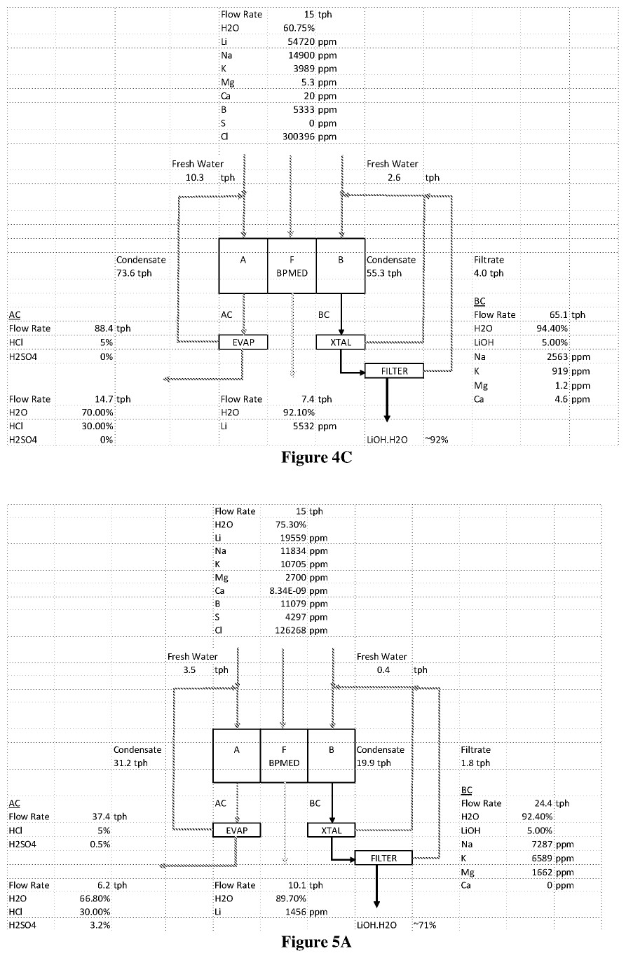

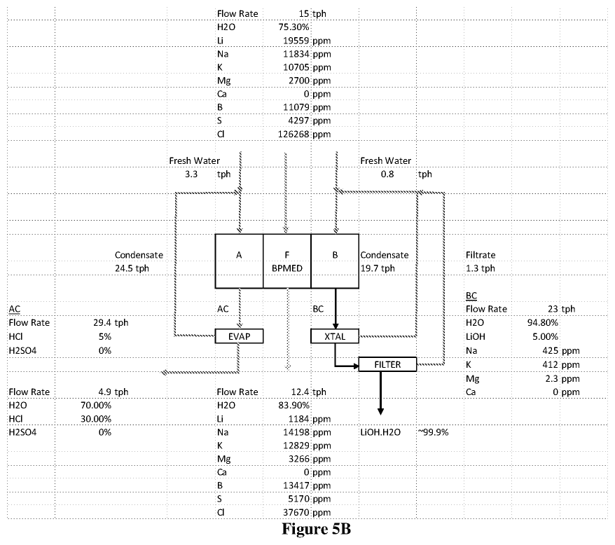

In another embodiment (FIG. 1c), BPMED can be applied after liming or after liming and softening steps when the feed brine contains excessively high amounts of multivalent ions, typically a Li/Mg and Li/Ca ratios greater than 5 and greater than 2, respectively. The liming and softening steps, however, increase the sodium content of the feed brine by replacing the Mg ions with Ca and the Ca ions with Na. In this case a lithium selective membrane discriminating between Li and Na is most preferred. However, a cation over anion selective membrane, which only discriminate between cations and anions, may also be used in some cases for a viable process, mainly after softening, to produce a viable product (FIGS. 4c and 5c). In some cases, conventional ED membranes remain unviable as shown by the high Ca levels resulting in the catholyte (stream BC in the Figures) containing high Ca levels, which will tend to precipitate in the ED cell. Even when the conventional ED membranes give a potentially viable product, in most cases like in FIG. 5c, the product will be of relatively low quality, requiring additional processing steps similar to the steps shown in FIG. 1a, i.e., LiOH recrystallization and ion exchange (IX) to remove Na, K and other trace impurities.

The inventors have surprisingly found that it is possible via the use of suitably selective membranes in ED to reduce or eliminate most of the processing steps required in the conventional LiOH production. Based upon the teachings and illustrative embodiments herein, other embodiments rearranging the process steps or including additional steps would be optional to a person of ordinary skill in the art. For example, other embodiments may include solvent extraction (SX) of boron from the feed brine or IX for boron removal from the feed brine or during LiOH crystallization.

### EXAMPLES

### Analytical Methods:

Multiple real-life brine examples from different geographies and sources are provided in the following paragraphs that demonstrate the applicability of the systems and methods described herein in a wide variety of cases. Based on realistic brine chemistries, electrodialysis separation was modeled with and without lithium selective membranes.

For the lithium selective membranes, a Li—Mg,Ca selectivity of 100 was used based on the documented performance of a LiTAS™ membrane. A Li—Na,K selectivity of 50 was used for this selective membrane. Conventional ED modeling has no selectivity between cations. Selectivity is defined here as the ratio of Li ions recovered/feed Li concentration, to the ratio of other cation recovered/other cation feed concentration. Lithium hydroxide concentration in all cases was set at 5%, which is near the solubility limit. Hydrochloric acid concentration also was set at 5% exiting ED. A per pass recovery of 95% for Li and 100% for other cations in non-selective membranes was used. The other cation recovery was set higher as Li is the major component in these brines and other cations would be recovered to a higher degree as the process continues to reach 95% Li recovery. For the Li selective membranes, the same Li recovery of 95% was used while the other cation recovery was determined based on the selectivity and relative concentrations. The lithium hydroxide and hydrochloric acid solutions were set as evaporated to a 14% solubility limit of LiOH and to 30% HCl, respectively. In sulfate systems, sulfuric acid was set as concentrated to 65%. The vapor from these evaporations would be condensed and returned to the ED cell as carrier fluid for additional LiOH and HCl/H₂SO₄ being recovered. A steady-state mass balance model incorporating the BPMED separation, evaporation, crystallization of lithium hydroxide monohydrate and filtration was thus developed. Different feed chemistries were run through the model to predict the system at equilibrium state. Particularly, the impurities in the base compartment exit stream were of interest to ensure that Mg and Ca levels remain in solution.

### Example 1, Chilean Evaporation Pond Brine

The performance of a cation selective ED membrane versus a Li selective membrane operating in a BPMED setup on concentrated feed brine is shown in FIG. 4. The feed to ED is the pond concentrated brine, e.g., natural brine after a degree of solar evaporation (for example, 98% volume). This is a typical Chilean concentrated brine composition with a Li/Mg ratio of approximately 10. Additional make-up fresh water is shown added separately to the acid and base compartments to replenish the water exiting with the concentrated acid and base streams, as well as the water of crystallization in LiOH·H₂O. Most of the carrier water is recirculated evaporator crystallizer vapor condensate. Li-depleted effluent from BPMED can be recycled to the evaporation ponds. Comparison of the base compartment exit composition between FIG. 4a (non-selective membranes) and 3b (selective membranes) shows a marked difference in the impurity levels of the resulting LiOH streams. In reality, Mg concentrations of around 1200 ppm in the base stream exiting ED in FIG. 4a are not possible as this concentration exceeds the solubility of Mg in this solution. Mg will precipitate at these concentrations making the use of conventional ED membranes impossible. Maximum Mg and Ca levels in this stream need to be less than 3 ppm and 5 ppm respectively to stay in solution as is achievable with the Li selective membranes. With a Li selective membrane, the impurity profile of the LiOH stream makes it amenable to direct crystallization to a commercially saleable lithium product as seen in FIG. 4b.

FIG. 4c shows application of BPMED using cation exchange membranes (which are not selective between different types of cations) to the process stream after the concentrated feed brine has been treated with lime-soda softening to precipitate multivalent cations. The LiOH concentrated stream in this case shows low levels of Mg and Ca, but high K and an elevated Na content. Production of lithium hydroxide from this stream may optionally include LiOH recrystallization and IX polishing in addition to the upfront lime-soda softening. This still provides a considerable improvement over the conventional production process because lithium carbonate production is bypassed and the process steps are significantly reduced. The purity of lithium hydroxide monohydrate achieved in cases a, b and c are 95%, 99.9% and 92% respectively.

### Example 2, Argentinian Evaporation Pond Brine

The mass balance summary of treating this brine with ED is shown in FIG. 5. FIG. 5a shows the direct treatment using a cation selective ED membrane. Concentrated pond brine is at 1.9% Li with other components as shown in the figure. Non-selective (conventional) ED yields Mg levels in the base compartment of 1662 ppm, which is significantly higher than the less than 3 ppm required to prevent precipitation. Hence, this conventional membrane separation is not preferred in comparison to the systems and methods taught herein using suitable ED membranes for direct LiOH production.

FIG. 5b shows treatment using lithium selective ED membranes. Mg and Ca levels in the base compartment are below the 3 ppm and 5 ppm maximum levels. Notably, Na and K levels are also low, resulting in a high purity LiOH·H₂O product.

FIG. 5c shows treatment of brine using a cation selective ED membrane after subjecting the brine to a lime soda softening process for divalent and multivalent cation removal. In this case, the Mg and Ca levels in the base compartment are at an acceptable level. So, the process is possible; however, due to the high Na and K levels in the base compartment, a relatively crude (˜71% LiOH·H₂O) product is produced with a 60% lower Li current efficiency.

### Example 3, Hardrock (Spodumene) Acid Roasting Leach Liquor

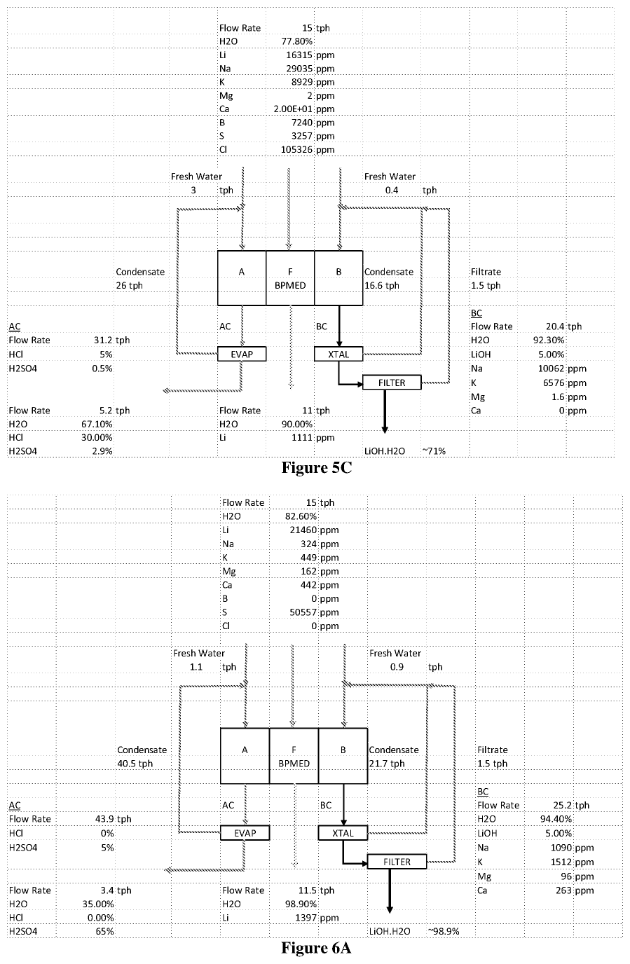

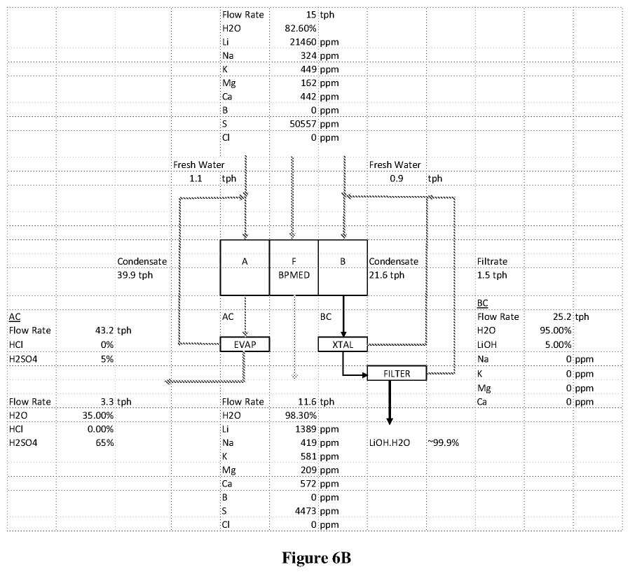

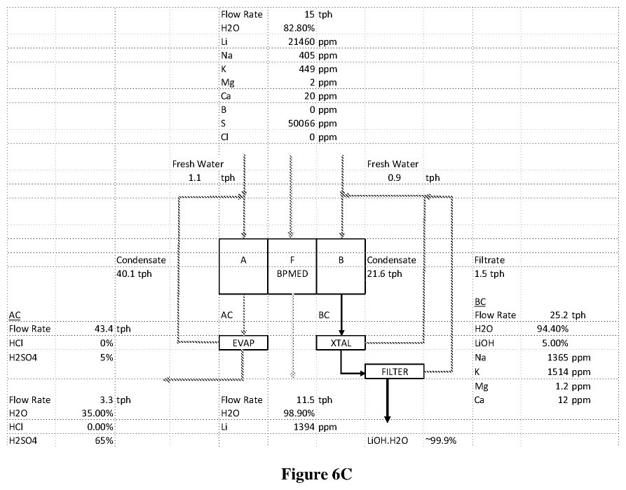

The mass balance summary of treating this material via ED is shown in FIG. 6. The acid roasted leach composition as shown was obtained from Bourassa, 2019. FIG. 6a shows the direct treatment using a cation selective conventional ED membrane. Concentrated leach liquor is at 2.1% Li with other components as shown in the figure. This is a typical sulfate system. Cation selective conventional ED yields Mg levels in the base compartment of 96 ppm and Ca of 263 ppm, which are generally impractical (FIG. 6a). As shown in FIG. 6c, after the leach liquor is softened, Ca and Mg levels are reduced to 2 and 20 ppm, respectively. The base compartment solution is now at an acceptable Mg concentration of 1.2 ppm. However, the Ca concentration at 12 ppm make this application generally impractical for most purposes. However, by using Li selective membranes a very clean Li₀H·H₂O product is possible (FIG. 6c).

In addition to the above, additional examples for typical Bolivian brine and other Chilean brines are provided in Table 1. It can be seen that the application of Li-selective ED is beneficial in all cases. Lithium selective membrane electrodialysis on brines evaporated by solar or DLE means or concentrated feed can unlock the pathway to direct lithium hydroxide production from feed brines, direct lithium extraction, and mineral leachates. In specific situations (with the exception of hard rock spodumene) softening of the feed brine is optional before application of conventional noncationic selective ED. The product in such cases, however, may be relatively crude, e.g., contaminated with hydroxides of Na and K which will require additional purification. Lower lithium current efficiency will also result from recovery of impurity hydroxides.

Li-selective ED provides an efficient pathway to direct LiOH production in all major lithium sources such as south American brines and spodumene which account for nearly all the lithium supply today. The systems and methods taught herein also are applicable to other sources of lithium such as hectorite clays, jadarite, zinnwaldite, etc. The methods significantly simplify the processes, which will result in reduced capital, operating and reagent costs, and lower production costs. Other advantages include the ability to process significantly less concentrated feed and obtain higher lithium recovery, because losses with precipitates are avoided both in the ponds and the processing plant.
Table 1. Concentrated LiOH (5%) solution impurity profiles for various realistic brine and hard-rock sources treated using the methodology disclosed herein. BPMED used with Li-selective membranes yield best products. BPMED used on softened feed with cation over anion selective membranes yields a feasible process in most cases but with less pure products. Liquors treated are either concentrated Li brines from evaporation ponds or leach liquors from spodumene roasting and leaching. In some cases, feed liquors also include those after initial lime-soda softening for removal of multivalent cations.

TABLE 1

| | | | Impurity Concentration Profile (ppm) | | | |
|---|---|---|---|---|---|---|
| Source | Location | ED Type | Mg | Ca | Na | K |
| Chile I | Feed | Cation selective* | 1236* | 184* | 200 | 5239 |
| | Feed | Li-Selective | 1.1 | 0 | 0 | 7 |
| | Softened | Cation selective⁺ | 1.2 | 4.6 | 2563 | 919 |
| Chile II | Feed | Cation selective* | 739* | 0 | 840 | 1108 |
| | Feed | Li-Selective | 0.34 | 0 | 0.87 | 1.5 |
| | Softened | Cation selective⁺ | 0.74 | 0 | 1484 | 1108 |
| Bolivia | Feed | Cation selective* | 406* | 0 | 3 | 2 |
| | Feed | Li-Selective | 0.1 | 0 | 0 | 0 |
| | Softened | Cation selective⁺ | 0.4 | 0 | 643 | 2 |
| Argentina | Feed | Cation selective* | 1662* | 0 | 7287 | 6589 |
| | Feed | Li-Selective | 2.3 | 0 | 425 | 412 |
| | Softened | Cation selective⁺ | 1.6 | 0 | 10062 | 6576 |
| Hardrock | Feed | Cation selective* | 96* | 263* | 1090 | 1512 |
| | Feed | Li-Selective | 0 | 0 | 0 | 0 |
| | Softened | Cation selective* | 1.2 | 12* | 1365 | 1514 |

*Precipitation making process infeasible.
⁺Feasible but less desirable due to higher impurities in product necessitating reprocessing.

Table 1. Concentrated LiOH (5%) solution impurity profiles for various realistic brine and hard-rock sources treated using the methodology disclosed herein. BPMED used with Li-selective membranes yield best products. BPMED used on softened feed with cation over anion selective membranes yields a feasible process in most cases but with less pure products. Liquors treated are either concentrated Li brines from evaporation ponds or leach liquors from spodumene roasting and leaching. In some cases, feed liquors also include those after initial lime-soda softening for removal of multivalent cations.

### REFERENCES

Bourassa, G., Pearse, G., Mackie, S. C., Gladkovas, M., Symons, P., Genders, J. D., & Magnan, J. (2020). U.S. Pat. No. 10,633,748 B2. Washington, DC: U.S. Patent and Trademark Office.
Buckley, D. J., Genders, J. D., & Atherton, D. (2009). International Publication No. WO2009131628A1. World Intellectual Property Organization International Bureau.
Bunani, S., Arda, M., Kabay, N., Yoshizuka, K., & Nishihama, S. (2017). Effect of process conditions on recovery of lithium and boron from water using bipolar membrane electrodialysis (BMED). Desalination, 416, 10-15. https://doi.org/10.1016/j.desal.2017.04.017
Bunani, S., Yoshizuka, K., Nishihama, S., Arda, M., & Kabay, N. (2017). Application of bipolar membrane electrodialysis (BMED) for simultaneous separation and recovery of boron and lithium from aqueous solutions. Desalination, 424, 37-44. https://doi.org/10.1016/j.desal.2017.09.029
Demeter, E., Connor, M. J., & McDonald, B. M. (2020). U.S. Patent No. US 2020/0001251 A1. Washington, DC: U.S. Patent and Trademark Office.
Gmar, S., & Chagnes, A. (2019). Recent advances on electrodialysis for the recovery of lithium from primary and secondary resources. Hydrometallurgy, 189, 105124. https://doi.org/10.1016/j.hydromet.2019.105124
Grageda, M., Gonzalez, A., Quispe, A., & Ushak, S. (2020). Analysis of a Process for Producing Battery Grade Lithium Hydroxide by Membrane Electrodialysis. Membranes, 10(9), 198. https://doi.org/10.3390/membranes10090198
Jiang, C., Wang, Y., Wang, Q., Feng, H., & Xu, T. (2014). Production of Lithium Hydroxide from Lake Brines through Electro-Electrodialysis with Bipolar Membranes (EEDBM). Industrial & Engineering Chemistry Research, 53(14), 6103-6112. https://doi.org/10.1021/ie404334s
Li, X., Mo, Y., Qing, W., Shao, S., Tang, C. Y., & Li, J. (2019). Membrane-based technologies for lithium recovery from water lithium resources: A review. Journal of Membrane Science, 591, 117317. https://doi.org/10.1016/j.memsci.2019.117317
Lide, D. R. (ed.), 2004, CRC Handbook of Chemistry and Physics, 85^{th} Edition, CRC Press, ISBN 978-0849304859.
Lu, J., Zhang, H., Hou, J., Li, X., Hu, X., Hu, Y., Easton, C. D., Li, Q., Sun, C., Thornton, A. W., Hill, M. R., Zhang, X., Jiang, G., Liu, J. Z., Hill, A. J., Freeman, B. D., Jiang, L., & Wang, H. (2020). Efficient metal ion sieving in rectifying subnanochannels enabled by metal-organic frameworks. Nature Materials, 19(7), 767-774. https://doi.org/10.1038/s 41563-020-0634-7
Meng, F., McNeice, J., Zadeh, S. S., & Ghahreman, A. (2021). Review of Lithium Production and Recovery from Minerals, Brines, and Lithium-Ion Batteries. Mineral Processing and Extractive Metallurgy Review, 42(2), 123-141. https://doi.org/10.1080/08827508.2019.1668387
Nie, X.-Y., Sun, S.-Y., Sun, Z., Song, X., & Yu, J.-G. (2017). Ion-fractionation of lithium ions from magnesium ions by electrodialysis using monovalent selective ion-exchange membranes. Desalination, 403, 128-135. https://doi.org/10.1016/j.desal.2016.05.010
Park, S. K., Park, K. S., Li, S. G., Jung, W. C., Kim, K. Y., & Lee, H. W. (2020). U.S. Pat. No. 10,661,227 B2. Washington, DC: U.S. Patent and Trademark Office.
Qiu, Y., Yao, L., Tang, C., Zhao, Y., Zhu, J., & Shen, J. (2019). Integration of selectrodialysis and selectrodialysis with bipolar membrane to salt lake treatment for the production of lithium hydroxide. Desalination, 465, 1-12. https://doi.org/10.1016/j.desal.2019.04.024
Zhao, Y., Wang, H., Li, Y., Wang, M., & Xiang, X. (2020). An integrated membrane process for preparation of lithium hydroxide from high Mg/Li ratio salt lake brine. Desalination, 493, 114620. https://doi.org/10.1016/j.desal.2020.114620

What is claimed is:

1. A method for producing a LiOH solution from an admixture containing Li and one or more impurities, comprising:
(A) feeding the admixture to an ED cell containing an ion selective membrane; and
(B) applying a potential difference to the ion selective membrane to obtain a separate LiOH solution;
wherein the separate LiOH solution contains LiOH, less than about 25 ppm Mg, and less than about 50 ppm Ca.

2. The method of claim 1, wherein the LiOH solution comprises from about 5 to about 25 ppm Mg.

3. The method of either claim 1 or claim 2, wherein the LiOH solution comprises from about 5 to about 50 ppm Ca.

4. The method according to any one of claims 1-3 wherein the separate LiOH solution comprises about 2 to about 14% LiOH and water.

5. The method according to any one of claims 1-4, wherein the ion selective membrane is contained within a bipolar membrane electrodialysis cell.

6. The method according to any one of claims 1-5, wherein the admixture contains lithium in an amount of about 1,000 to about 60,000 ppm.

7. The method according to any one of claims 1-6, wherein the admixture contains impurity ions selected from the group consisting of monovalent and divalent cations and divalent anions.

8. The method according to any one of claims 1-7, wherein the admixture contains impurity ions selected from the group consisting of K, Na, Mg, and Ca ions.

9. The method of claim 8, wherein the impurity ion is K.

10. The method of claim 8, wherein the impurity ion is Na.

11. The method of claim 8, wherein the impurity ion is Mg.

12. The method of claim 8, wherein the impurity ion is Ca.

13. The method according to any one of claims 1-12, wherein the admixture contains a ratio of Li/Mg ions greater than about 2.

14. The method according to any one of claims 1-13, wherein the admixture contains a ratio of Li/Ca ions greater than about 3.

15. The method according to any one of claims 1-14, wherein the admixture contains a ratio of Li/Na ions greater than about 1.5.

16. The method according to any one of claims 1-15, wherein the admixture contains a ratio of Li/K ions greater than about 1.5.

17. The method according to any one of claims 1-16, wherein the admixture is a concentrated lithium brine from a process selected from the group consisting of pond evaporation, direct lithium extraction, and leaching of lithium minerals using water, base or acid.

18. The method of claim 17, wherein the admixture is pond evaporated brine.

19. The method of claim 17, wherein the admixture comprises a rock leachate.

20. The method of claim 17, wherein the admixture is a DLE produced brine.

21. The method according to any one of claims 17-20, wherein the admixture has been treated to remove impurities.

22. The method according to any one of claims 17-20, wherein the admixture is untreated.

23. The method according to any one of claims 1-22, wherein the ion selective membrane is selected from the group consisting of a lithium selective membrane, a monovalent selective membrane, and a cation over anion selective membrane.

24. The method according to any one of claims 1-23, wherein the ion selective membrane is a lithium selective membrane.

25. The method according to any one of claims 1-24, wherein the ion selective membrane is a lithium selective membrane having a selectivity in the range of Li/Mg,Ca of at least 10

26. The method according to any one of claims 1-25, wherein the ion selective membrane is a lithium selective membrane having a selectivity in the range of Li/Na K of at least 3.

27. The method according to any one of claims 1-26, wherein the ion selective membrane is a lithium selective membrane comprising a polymer matrix.

28. The method according to any one of claims 1-27, wherein the ion selective membrane is a lithium selective membrane comprising a polymer matrix and MOF particles disbursed therein.

29. The method according to any one of claims 1-28, wherein the ion selective membrane is a cation over anion selective membrane and liming or softening is performed before feeding the admixture to the ED cell.

30. The method according to any one of claims 1-29, wherein the process is substantially free of a lithium carbonate precursor to LiOH.

31. The method according to any one of claims 1-30 further comprising precipitating a portion of the admixture as a lithium precipitate prior to feeding the admixture to the ED cell such that at least a portion of the feed then advances through electrodialysis to directly produce LiOH.

32. The method according to any one of claim 31, wherein the lithium precipitate comprises a material selected from the group consisting of lithium carbonate, lithium phosphate, and lithium oxalate.

33. The method according to any one of claims 1-32 further comprising subjecting the lithium hydroxide solution to crystallization to produce lithium hydroxide monohydrate.

34. The method according to any one of claims 1-33, wherein the lithium hydroxide solution comprises lithium hydroxide in the range of about 2 to about 14%.

35. The method according to any one of claims 1-34, wherein the lithium hydroxide monohydrate has a purity in the range of greater than 95 to 99.9 wt %.

36. The method of claim 35, wherein the lithium hydroxide monohydrate has a purity in the range of 95 to 99.9 wt %.

37. The method according to claims 1-36 further comprising performing boron solvent extraction or ion exchange before feeding the admixture to the membrane.

38. The method according to any one of claims 1-37, wherein the admixture is an evaporated concentrate from a series of brine ponds and the method further comprising membrane separation of Mg and recycle of the separated Mg to a previous pond for precipitation to produce a lower Mg content feed to the ED cell.

39. The method according to any one of claims 1-38, wherein the admixture is subject to liming and softening for removing multivalent ions before feeding the admixture to the ED cell.

40. The method according to any one of claims 1-39, further comprising subjecting the LiOH solution to ion exchange.

41. A system configured to produce LiOH from an admixture containing Li and one or more impurities, comprising:
(A) an ion selective membrane selected from the group consisting of a lithium selective membrane, a monovalent selective membrane, or a cation over anion selective membrane;
(B) a feed inlet upstream of the membrane and configured to receive an admixture comprising a concentrated lithium brine from a process selected from the group consisting of pond evaporation, direct lithium extraction, and leaching of lithium minerals using water or acid; and
(C) an outlet downstream of the membrane configured to convey a LiOH solution containing about 2 to 14 wt % LiOH, less than 25 ppm Mg, and less than 50 ppm Ca.

42. The system of claim 41, wherein the LiOH solution comprises from about 5 to about 25 ppm Mg.

43. The system of either claim 41 or claim 42, wherein the LiOH solution comprises from about 5 to about 50 ppm Ca.

44. The system according to any one of claims 41-43, wherein the membrane is a lithium selective membrane.

45. The system according to any one of claims 41-44, wherein the membrane is a lithium selective membrane comprising a polymer matrix.

46. The system of claim 45, wherein the membrane is a lithium selective membrane comprising a polymer matrix and MOF particles disbursed therein.

47. The system according to any one of claims 41-45, wherein the ion selective membrane is a lithium selective membrane having a selectivity in the range of Li/Mg,Ca of at least 10

48. The system according to any one of claims 41-47, wherein the ion selective membrane is a lithium selective membrane having a selectivity in the range of Li/Na, K of at least 3.

49. The system according to any one of claims 41-48, wherein the membrane is a lithium selective membrane.

50. The system according to any one of claims 41-49, wherein the membrane is part of an ED cell.

51. The system according to any one of claims 41-50, wherein the membrane is part of a BPMED cell.

52. The system according to any one of claims 41-51, further comprising an outlet upstream of the membrane and configured to convey a portion of the admixture as a lithium precipitate, such that at least a portion of the admixture then advances through electrodialysis to directly produce LiOH.

53. The system of claim 52 wherein the lithium precipitate comprises a material selected from the group consisting of lithium carbonate, lithium phosphate, and lithium oxalate.
